(19) United States
(12) Patent Application Publication
(10) Pub. No.: US 2026/0128211 A1
(43) Pub. Date: May 7, 2026

(54) COIL ELECTRONIC COMPONENT

(71) Applicant: SAMSUNG ELECTRO-MECHANICS CO., LTD., Suwon-si (KR)

(72) Inventors: Jungmin Park, Suwon-si (KR); Boumseock Kim, Suwon-si (KR)

(73) Assignee: SAMSUNG ELECTRO-MECHANICS CO., LTD., Suwon-si (KR)

(21) Appl. No.: 19/094,271

(22) Filed: Mar. 28, 2025

(30) Foreign Application Priority Data
Nov. 5, 2024 (KR) 10-2024-0154924

(51) Int. Cl. H01F 27/32; H01F 27/29

(52) U.S. Cl. CPC H01F 27/323; H01F 27/292

(57) ABSTRACT

A coil type electronic component includes a body comprising a magnetic material, a coil embedded within the body and having a plating layer, and an insulation member comprising glass that covers the coil. The plating layer comprises a first plating layer and a second plating layer disposed over the first plating layer. The insulation member includes an inner insulation member positioned between a first coil pattern and a second coil pattern and an insulation wall extending between adjacent turns of the coil to enhance electrical insulation and structural integrity. A first external electrode and a second external electrode are positioned outside the body and electrically connected to the coil. The insulation member improves mechanical stability and electrical performance, mitigating deformation and potential short circuits.

### CROSS-REFERENCE TO RELATED APPLICATION

This application claims priority to and the benefit of Korean Patent Application No. 10-2024-0154924 filed with the Korean Intellectual Property Office on Nov. 5, 2024, the entire contents of which are incorporated herein by reference.

### BACKGROUND

### 1. Field

The present disclosure relates to a coil type electronic component.

### 2. Description of the Related Art

As power consumption increases as a function of a mobile device has diversified in recent years, a coil electronic component having small loss and excellent efficiency is adopted around a power management integrated circuit (PMIC) to increase a battery life in mobile devices.

There is a growing demand for a thin power inductor to make products slimmer and increase flexibility in component arrangement. Among them, the thin-film inductor can be manufactured by forming a coil on a support member with sputtering or plating. The support member can be deformed by heat or pressure during a process of manufacturing the thin-film inductor. When the support member is deformed, the alignment of the coil may be distracted, exposing the coil to the outside or causing a short, which may reduce the reliability of the thin-film inductor.

### SUMMARY

One aspect of an embodiment aims to provide a coil type electronic component having enhanced reliability.

However, problems addressed by the embodiments are not limited to the above-mentioned problems, but can be variously extended within the scope of the technical spirit included in the embodiments.

An embodiment provides a coil electronic component which includes: a body including a magnetic material; a coil embedded in the body and including a plating layer; and an insulation member made of glass covering the coil, in which the plating layer includes a first plating layer and a second plating layer covering the first plating layer.

A portion of the first plating layer may be in contact with the second plating layer and the remaining portion may be in contact with the insulation member.

The coil may include a first coil pattern and a second coil pattern, and the insulation member may include an inner insulation member disposed between the first coil pattern and the second coil pattern.

The inner insulation member may include a first support surface and a second support surface opposing each other, and the first coil pattern may be disposed on the first support surface, and the second coil pattern may be disposed on the second support surface.

The coil type electronic component may further include a first via penetrating the internal insulation member, and connecting the first coil pattern and the second coil pattern.

The insulation member may include an outer insulation member disposed between the coil and the body.

The outer insulation member may be disposed on an outer surface of the coil.

The second plating layer may be in contact with the outer insulation member.

The body may include a first surface and a second surface opposing each other in a first direction, the coil may include a plurality of turns wound about a winding axis in the first direction, and the insulation member may include an insulation wall disposed between the turns of the coil.

The insulation member may include a photosensitive glass.

The insulation member may include at least one of SiO₂—B₂O₃-based glass, SiO₂—B₂O₃—K₂O-based glass, SiO₂—B₂O₃—Li₂O—CaO-based glass, SiO2—B₂O3—Li₂O—CaO—ZnO-based glass, and Bi₂O₃—B₂O₃—SiO₂—Al₂O₃-based glass.

The insulation member may include at least one of quartz, alumina, magnesia, silica, forsterite (Mg₂SiO₄), steatite (H₂Mg₃(SiO₃)₄), and zirconia.

The body may include a first surface and a second surface opposing each other in a first direction, the coil may be wound about a winding axis in the first direction, and the coil may include a lead-out terminal exposed from the first surface or the second surface of the body.

The coil type electronic component may further include an external electrode disposed outside the body and connected to the lead-out terminal.

The external electrode may be disposed on the first surface or the second surface of the body.

The coil type electronic component may further include a surface insulation layer disposed on an outer surface of the body.

According to an embodiment, a coil type electronic component with enhanced reliability can be provided.

### BRIEF DESCRIPTION OF THE DRAWINGS

FIG. 1 is a perspective view schematically illustrating a coil type electronic component according to an embodiment.

FIG. 2 is a schematic cross-sectional view taken along line I-I′ of FIG. 1.

FIG. 3 is a schematic cross-sectional view taken along line II-II′ of FIG. 1.

FIG. 4 is a cross-sectional view schematically illustrating a coil of FIG. 1.

FIGS. 5 to 19 are drawings sequentially illustrating a method for manufacturing a coil type electronic component according to an embodiment.

### DETAILED DESCRIPTION

Hereinafter, embodiments of the present disclosure will be described in detail so as to be easily implemented by those skilled in the art, with reference to the accompanying drawings. The drawings and descriptions are to be regarded as illustrative in nature and not restrictive. Like reference numerals designate like elements throughout the specification. Furthermore, some components in the drawing may be exaggerated, omitted, or schematically illustrated, and a size of each component does not reflect the actual size entirely

It is to be understood that the accompanying drawings are provided solely to facilitate understanding the embodiments disclosed in this specification and a technical spirit disclosed in this specification is not limited by the accompanying drawings and all modifications, equivalents, or substitutes included in the spirit and the technical scope of the present disclosure are included.

Terms including an ordinary number, such as first and second, are used for describing various components, but the components are not limited by the terms. The terms are used solely to distinguish one component from another component.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, to be referred to as “on” or “on” a reference portion is located above or below the reference portion, and does not particularly mean to “above”or “on”the direction opposite to gravity.

Throughout this specification, it should be understood that the terms “include” or “have” indicate the presence of a feature, number, step, operation, component, part, or combination thereof, but do not exclude the possibility of the presence or addition of one or more other features, numbers, steps, operations, components, parts, or combinations thereof. Accordingly, unless explicitly described to the contrary, the word “comprise”, and variations such as “comprises” or “comprising”, will be understood to imply the inclusion of stated elements but not the exclusion of any other elements.

Furthermore, throughout the specification, “plan view” means that a target part is viewed from the top, and “cross-sectional view” means that a cross section vertically cutting the target part is viewed from the side.

In addition, throughout the specification, the term “connected” does not necessarily mean that two or more components are directly connected, but may mean being indirectly connected to the two or more components through other components, and electrically connected, or may be referred to as different names according to a location or function, but may be integrated.

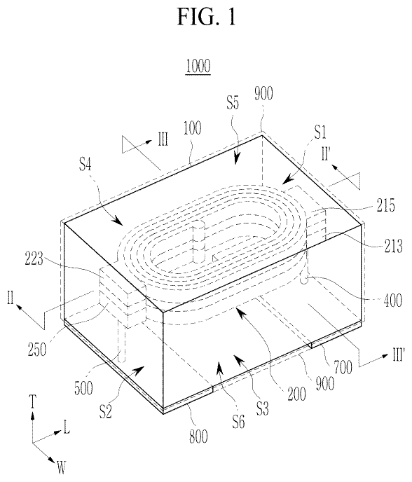

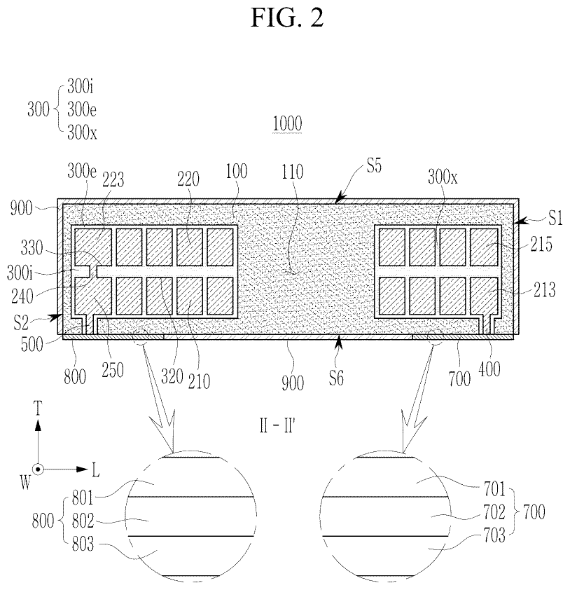

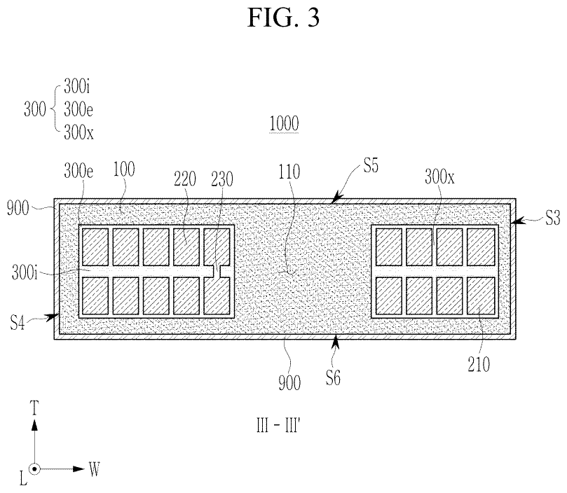

FIG. 1 is a perspective view schematically illustrating a coil type electronic component according to an embodiment, FIG. 2 is a schematic cross-sectional view taken along line I-I′ of FIG. 1, and FIG. 3 is a schematic cross-sectional view taken along line II-II′ of FIG. 1.

Referring to FIGS. 1, 2, and 3, the coil electronic component 1000 includes a body 100, a coil 200, an insulation member 300, a first external electrode 700, a second electrode 800, and a surface insulation layer 900.

The body 100 may have a substantially rectangular parallelepiped shape, but the embodiment is not limited thereto. Due to shrinkage of magnetic powders etc., during sintering, the body 100 may not have a perfect rectangular parallelepiped shape, but may have a substantially rectangular parallelepiped shape. For example, although the body 100 has a substantially rectangular parallelepiped shape, portions corresponding to a corner or a vertex may have a round shape.

In the present embodiment, for convenience of description, two surfaces of the body opposing each other in a length direction (L-axis direction) will be defined as a first surface S1 and a second surface S2, two surfaces of the body 100 opposing each other in a width direction (W-axis direction) will be defined as a third surface S3 and a fourth surface S4, and two surfaces of the body 100 opposing each other in a thickness direction (T-axis direction) will be defined as a fifth surface S5 and a sixth surface S6.

A length of the coil electronic component 1000 may mean, based on an optical microscope or a scanning electron microscope (SEM) photograph of a cross-section taken along the length direction (L-axis direction)-thickness direction (T-axis direction) at a center of the coil electronic component 1000 in the width direction (W-axis direction), a maximum value of lengths of a plurality of line segments which connect two outermost boundary lines opposing each other in the length direction (L-axis direction) of the coil electronic component 1000 shown the above-described cross-sectional photograph, respectively, and are parallel to the length direction (L-axis direction), length direction. Alternatively, the length of the coil electronic component 1000 may mean a minimum value among lengths of a plurality of line segments which connect two outermost boundary lines opposing each other in the length direction (L-axis direction) of the coil electronic component 1000 shown in the cross-sectional photograph, respectively, and are parallel to the length direction (L-axis direction). Alternatively, the length of the coil-type electronic component 1000 may be defined as the arithmetic mean value of the lengths of at least two line segments among multiple line segments that connect two outermost boundary lines opposing each other in the length direction (L-axis direction), as shown in the cross-sectional photograph, and are parallel to the length direction (L-axis direction).

A thickness of the coil electronic component 1000 may mean, based on an optical microscope or scanning electron microscope (SEM) photograph of a cross-section taken along the length direction (L-axis direction)-thickness direction (T-axis direction) at a center of the coil electronic component 1000 in the width direction (W-axis direction), a maximum value of lengths of a plurality of line segments which connect two outermost boundary lines opposing each other in the thickness direction (T-axis direction) of the coil electronic component 1000 shown the above-described cross-sectional photograph, respectively, and are parallel to the thickness direction (T-axis direction),. Alternatively, the thickness of the coil electronic component 1000 may mean a minimum value among lengths of a plurality of line segments which connect two outermost boundary lines opposing each other in the thickness direction (T-axis direction) of the coil electronic component 1000 shown in the cross-sectional photograph, respectively, and are parallel to the thickness direction (T-axis direction). Alternatively, the thickness of the coil electronic component 1000 may mean an arithmetic mean value of lengths of at least two line segments among a plurality of line segments, which connect two outermost boundary lines opposing each other in the thickness direction (T-axis direction) of the coil electronic component 1000 shown in the above-described cross-sectional photograph, and are parallel to the thickness direction (T-axis direction), respectively.

A width of the coil electronic component 1000 may mean, based on an optical microscope or a scanning electron microscope (SEM) photograph of a cross-section taken along the length direction (L-axis direction)-width direction (W-axis direction) at a center of the coil electronic component 1000 in the thickness direction (T-axis direction), a maximum value of lengths of a plurality of line segments which connect two outermost boundary lines opposing each other in the width direction (W-axis direction) of the coil electronic component 1000 shown the above-described cross-sectional photograph, respectively, and are parallel to the width direction (W-axis direction). Alternatively, the width of the coil-type electronic component 1000 may be defined as the minimum value among the lengths of multiple line segments that connect the two outermost boundary lines opposing each other in the width direction (W-axis direction), as shown in the cross-sectional photograph, and are parallel to the width direction (W-axis direction). Alternatively, the width of the coil electronic component 1000 may mean an arithmetic mean value of lengths of at least two line segments among a plurality of line segments, which connect two outermost boundary lines opposing each other in the width direction (W-axis direction) of the coil electronic component 1000 shown in the above-described cross-sectional photograph, and are parallel to the with direction (W-axis direction), respectively.

Each of the length, the width, and the thickness of the coil electronic component 1000 may also be measured using a micrometer measurement method. In the micrometer measurement method, a zero point is set using a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil type electronic component 1000 may mean a value measured once or mean an arithmetic average of values measured a plurality of times. This may be equally applied to measuring the width and the thickness of the coil electronic component 1000.

The body 100 constitutes an exterior of the coil type electronic component 1000, and is a space where a magnetic path, which is a path through which the magnetic flux generated by the coil 200 passes, is formed, when a current is applied to the coil 200 through the first external electrode 700 and the second external electrode 800.

The body 100 surrounds and encapsulates the coil 200 and the insulation member 300, and includes a magnetic material. The body 100 may include magnetic particles, and an insulation material may be interposed between the magnetic particles.

The magnetic material may include a first metal magnetic particle, a second metal magnetic particle having a smaller particle size than the first metal magnetic particle, and a third metal magnetic particle having a smaller particle size than the second metal magnetic particle. An average particle diameter D₅₀ of the first metal magnetic particle may be in a range from about 5 μm to about 30 μm, an average particle diameter D₅₀ of the second metal magnetic particle may be in a range from about 1 μm to about 5 μm, and an average particle diameter D₅₀ of the third metal magnetic particle may be in a range from about 0.05 μm to about 0.5 μm.

The magnetic particles may be ferrite particles or metal magnetic particles exhibiting magnetic properties.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrites.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particles may be amorphous or crystalline. For example, the metal magnetic particle may be an Fe—Si—B—Cr-based amorphous alloy, but the embodiment is not limited thereto. The metal magnetic particle may have an average diameter in a range from about 0.1 μm to about 30 μm, but the embodiment is not limited thereto.

In the present specification, the average diameter may mean a particle size distribution expressed by D₉₀, D₅₀, or the like. The particle size distribution is well known to those skilled in the art as an index indicating what size (particle size) particles are included in what proportion in a particle group to be measured. D₅₀ (a particle size corresponding to 50 % of a cumulative volume of the particle size distribution) refers to an average particle diameter.

The metal magnetic particles may be two or more types of different metal magnetic particles. Here, by different types of metal magnetic particles, it is meant that the metal magnetic particles are distinguished from each other in at least one of average particle size, composition, component ratio, crystallinity, and shape.

The insulation material may include epoxy, polyimide, liquid crystal polymer, etc., alone or in combination, but the embodiment is not limited thereto.

The insulation member 300 may be disposed inside the body 100, and may cover and support the coil 200.

The insulation member 300 may include glass.

For example, the glass included in the insulation member 300 may be SiO₂—B₂O₃-based glass, SiO₂—B₂O₃—K₂O-based glass, SiO₂—B₂O₃—Li₂O—CaO-based glass, SiO₂—B₂O₃—Li₂O—CaO—ZnO-based glass, and Bi₂O₃—B₂O₃—SiO₂—Al₂O₃-based glass. As another example, the insulation member 300 may be made of photosensitive glass including silica, lithium (Li) oxide, aluminum (Al), and cerium (Ce) oxide.

In an embodiment, the glass included in the insulation member 300 may also include filler. The filler included in the glass may include, for example, quartz, alumina, magnesia, silica, forsterite (Mg₂SiO₄), steatite (H₂Mg₃(SiO₃)₄), and zirconia.

The insulation member 300 may include an inner insulation member 300i, an outer insulation member 300e, and an insulation wall 300x.

The inner insulation member 300i may serve as a support member which supports the coil 200. Both a first coil pattern 210 and a second coil pattern 220 to be described later may be disposed to be in contact with the inner insulation member 300i. In other words, the inner insulation member 300i may be disposed between the first coil pattern 210 and the second coil pattern 220.

When viewed in the thickness direction (T-axis direction), the inner insulation member 300i may have a shape wider than a shape formed by the edges of the coil 200.

The inner insulation member 300i may include a first support surface 320 and a second support surface 330 opposite each other in the thickness direction (T-axis direction).

The outer insulation member 300e may be disposed between the coil 200 and the body 100. The outer insulation member 300e may be disposed along the surface of the coil 200. That is, the outer insulation member 300e may be disposed on each of an external surface of the coil 200 facing an outer surface of the body 100 and an external surface of the coil 200 facing a core 110. However, the outer insulation member 300e does not exist at a portion where the coil 200 is connected to the first external electrode 121 and the second external electrode 122.

The insulation wall 300x may be disposed between the turns of the coil 200. That is, the insulation wall 300x may be disposed between adjacent coils of the coil patterns 210 and 220.

The coil 200 is disposed inside the body 100, exhibiting the characteristics of the coil electronic component 1000. For example, when the coil electronic component 1000 of the embodiment is utilized as a power inductor, when current is applied to the coil 200, the coil type electronic component may serve to stabilize the power source of an electronic device by storing energy in the form of a magnetic field and maintaining the output voltage.

When viewed in the thickness direction (T-axis direction), the coil 200 may be spiral.

The coil 200 may be disposed on the first support surface 320 and the second support surface 330 of the inner insulation member 300i.

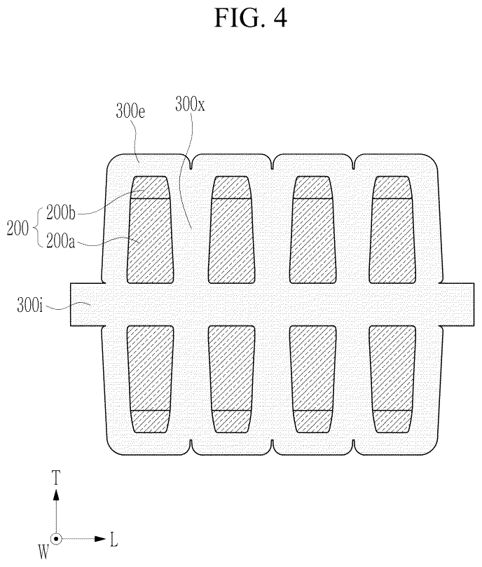

FIG. 4 is a cross-sectional view schematically illustrating the coil of FIG. 1.

Referring to FIG. 4, the coil 200 may have a multi-layer structure including two or more plating layers.

The coil 200 may be formed on a seed layer by a plating process, and for example, formed by an anisotropic plating process. When forming a coil by plating, if it is difficult to form a coil of the targeted thickness in a single plating, the plating process can be divided into several steps, resulting in a multilayer structure with two or more plating layers.

For example, the coil 200 may include a first plating layer 200a and a second plating layer 200b. However, the present embodiment is not limited thereto, so the coil 200 may include three or more plating layers.

The first plating layer 200a may be in contact with the inner insulation member 300i and may have a shape protruding in the thickness direction (T-axis direction).

The second plating layer 200b is not in contact with the inner insulation member 300i, but may cover a surface of the first plating layer 200a in the thickness-direction (T-axis direction).

When a cross section of the coil electronic component according to the embodiment is polished, and then etched in a sulfuric acid solution, the coil having the above-described multi-layer structure may be observed with a microscope.

The coil 200 may include the first coil pattern 210 and the second coil pattern 220, and the first coil pattern 210 and the second coil pattern 220 may be connected to each other through a first via 230 penetrating the inner insulation member 300i. The first coil pattern 210 and the second coil pattern 220 connected as such may form a spiral coil 200 having one or more turns.

The first coil pattern 210 is disposed on the first support surface 320 of the inner insulation member 300i.

The first coil pattern 210 includes a first lead-out portion 213. The first lead-out portion 213 may be electrically connected to the first external electrode 700 by a first lead-out terminal 400. For example, the first lead-out terminal 400 may be exposed on the sixth surface S6 of the body 100 and connected to the first external electrode 700.

The second coil pattern 220 is disposed on the second support surface 330 of the inner insulation member 300i.

The second coil pattern 220 includes a second lead-out portion 223. A connection portion 250 is disposed on the first support surface 320 of the inner insulation member 300i, and the connection portion 250 and the second lead-out portion 223 oppose each other in the thickness direction (T-axis direction). The connection portion 250 is connected to the second lead-out portion 223 via a second via 240 penetrating the inner insulation member 300i. The second lead-out portion 223 may be electrically connected to the second external electrode 800 via a second lead-out terminal 500. For example, the second lead-out terminal 500 may be exposed on the sixth surface S6 of the body 100 and connected to the second external electrode 800.

Each of the coil 200 and the via 230 may be made of a conductive material such as, copper (Cu), aluminum (Al), silver (Ag), tin (Sn), gold (Au), nickel (Ni), lead (Pb), titanium (Ti), an alloy thereof, or the like, but the embodiment is not limited thereto.

The insulation wall 300x is disposed between the adjacent coils of the first coil pattern 210 and the second coil pattern 220. The insulation wall 300x may have a shape that extends from the surface of the inner insulation member 300i in the thickness direction (T-axis direction) and connect to the outer insulation member 300e.

The insulation wall 300x includes glass, like the inner insulation member 300i and the outer insulation member 300e. Glass is stronger than polymer, so it is less likely to cause current leakage or short circuit in the coil.

Unlike the present embodiment, manufacturing a coil type electronic component by forming a coil on a PCB, stacking a magnetic body on the coil, and then pressing and curing the stacked magnetic body may cause deformation of the PCB. Since the PCB has relatively low rigidity and is vulnerable to thermal deformation, the PCB may undergo repeated pressure-induced deformation and thermal contraction/expansion during pressurization/curing of the magnetic body. If the PCB is deformed, the coil is exposed to the outside of the body, such that a short occurs or the coil is biased to one side within the body, causing a decrease in inductance and saturation current (Isat).

In contrast, according to the present embodiment, the insulation member 300 covering the coil 200 is made of glass and the glass serves as a support member and an insulating film, and as glass has a higher strength than polymers such as parylene and may be less susceptible to deformation. Although glass has a high strength, it also has a high brittleness and may crack under pressure, but to prevent this, an insulation member 300 made of glass is formed after the body 100 is formed, in the embodiment. This will be described later.

The first external electrode 700 and the second external electrode 800 are disposed outside the body 100, and connected to the coil 200.

The first external electrode 700 may be disposed on the sixth surface S6 of the body 100, and connected to the first lead-out portion 213 of the coil 200 through the first lead-out terminal 400.

The first external electrode 700 may include a first metal layer 701, a second metal layer 702, and a third metal layer 703.

The first metal layer 701 may be a plating layer in contact with the first lead-out terminal 400 and an outer surface, i.e., the sixth surface S6, of the body 100 and include copper (Cu). The second metal layer 702 may be a plating layer covering the first metal layer 701, and include nickel (Ni). The third metal layer 703 may be a plating layer covering the second metal layer 702, and include tin (Sn). However, the embodiment is not limited to a three-layer structure, and a two-layer structure with only one metal layer added onto the first metal layer 701 is also possible.

The first lead-out terminal 400 may be made of the same material as the coil 200. For example, both the first lead-out terminal 400 and the coil 200 may include copper (Cu).

The first lead-out terminal 400 may also be made of a different material from the coil 200. For example, the coil 200 may include copper (Cu), and the first lead-out terminal 400 may include gold (Au), aluminum (Al), silver (Ag), or alloys thereof. When the first lead-out terminal 400 is made of a different material from the coil 200, an intermetallic compound may be formed at an interface of the first lead-out terminal 400 and the coil 200.

The second external electrode 800 may be disposed on the sixth surface S6 of the body 100, and connected to the connection portion 250 of the coil 200 through the second lead-out terminal 500.

The second external electrode 800 may include a first metal layer 801, a second metal layer 802, and a third metal layer 803.

The first metal layer 801 may be a plating layer in contact with the second lead-out terminal 500 and an outer surface, i.e., the sixth surface S6, of the body 100 and include copper (Cu). The second metal layer 802 may be a plating layer covering the first metal layer 801, and include nickel (Ni). The third metal layer 803 may be a plating layer covering the second metal layer 802, and include tin (Sn). However, the embodiment is not limited to a three-layer structure, and a two-layer with only one metal layer added onto the first metal layer 801 is also possible.

The second lead-out terminal 500 may also be made of a different material from the coil 200. For example, the coil 200 may include copper (Cu), and the second lead-out terminal 500 may include gold (Au), aluminum (Al), silver (Ag), or alloys thereof. When the second lead-out terminal 500 is made of a different material from the coil 200, an intermetallic compound may be formed at an interface of the second lead-out terminal 500 and the coil 200.

As another example, the first external electrode 700 and the second external electrode 800 may include a conductive metal and glass. The conductive metal may be, for example, a conductive metal including copper (Cu), nickel (Ni), tin (Sn), palladium (Pd), platinum (Pt), gold (Au), silver (Ag), tungsten (W), titanium (Ti), lead (Pb) alone, or alloys thereof. The glass component included in the first external electrode 700 and the second external electrode 800 may be a mixture of oxides. The glass component may include, for example, a silicon oxide, a boron oxide, an aluminum oxide, a metastasis metal oxide, an alkaline metal oxide, an alkaline-earth metal oxide, or combinations thereof. Here, the transition metal may be selected from zinc (Zn), titanium (Ti), copper (Cu), vanadium (V), manganese (Mn), iron (Fe), or nickel (Ni), the alkaline metal may be selected from lithium (Li), sodium (Na), or potassium (K), and the alkaline-earth metal may be selected from magnesium (Mg), calcium (Ca), strontium (Sr), or barium (Ba). The method for forming the first external electrode 700 and the second external electrode 800 is not particularly limited. For example, the first external electrode 700 and the second external electrode 800 may be formed by dipping the body 100 into a conductive paste containing metal or glass or by printing a conductive paste onto the surface of the body 100 using, for example, screen printing or gravure printing. Further, various methods, such as applying a conductive paste on the surface of the body 100, or transferring a dry film formed by drying the conductive paste to the body 100, may be used to form the first external electrode 700 and the second external electrode 800.

The surface insulation layer 900 may be disposed on the first surface S1, the second surface S2, the fifth surface S5, and the sixth surface S6 of the body 100. However, the surface insulation layer 900 may only partially cover the sixth surface S6 of the body 100. That is, the first external electrode 700 and the second external electrode 800 may be disposed on the sixth surface S6 of the body 100, and the surface insulation layer 900 may not cover the first external electrode 700 and the second external electrode 800.

Meanwhile, the surface insulation layer 900 may also be disposed on the third surface S3 and the fourth surface S4 of the body 100.

As described above, the surface insulation layer 900 is disposed on at least a portion of the first surface S1, the second surface S2, the third surface S3, the fourth surface S4, the fifth surface S5, and the sixth surface S6 of the body 100 to prevent electrical shorts between other electronic components and the external electrodes 700 and 800.

The surface insulation layer 900 may be used as a resist when forming the first external electrode 700 and the second external electrode 800 by electroplating, but is not limited thereto.

The surface insulation layer may include polymer resin, pigment, filter, etc. The polymer resin may include a thermosetting polymer resin such as epoxy or a thermoplastic polymer resin such as acryl. Pigments capable of producing color such as black, may include carbon black, black manganese (Mn)-based spinel powder, etc. and the surface insulation layer may further include additives such as SiO₂ and talc, for control of strength and/or coefficient of thermal expansion.

For example, the surface insulation layer 900 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, a photosensitive resin, parylene, SiOₓ or SiNₓ.

The surface insulation layer 900 may be formed through a process such as screen printing, pad printing, dipping, spray printing, etc. For example, the surface insulation layer 900 may be formed by applying a liquid insulating resin to the surface of the body 100, stacking an insulating film such as a dry film on the surface of the body 100, or using a thin-film process such as vapor deposition. In the case of the insulating films, Ajinomoto Build-up Film (ABF) or polyimide film, or the like, which do not include a photosensitive insulating resin, may be used.

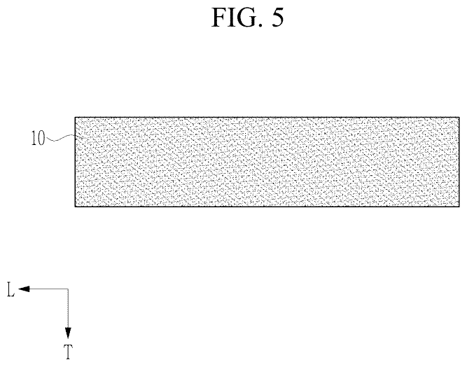

FIGS. 5 to 19 are drawings sequentially illustrating a method for manufacturing a coil electronic component according to an embodiment.

Referring to FIG. 5, a magnetic bar 10 is provided. For example, the magnetic bar 10 may be manufactured by stacking molded sheets.

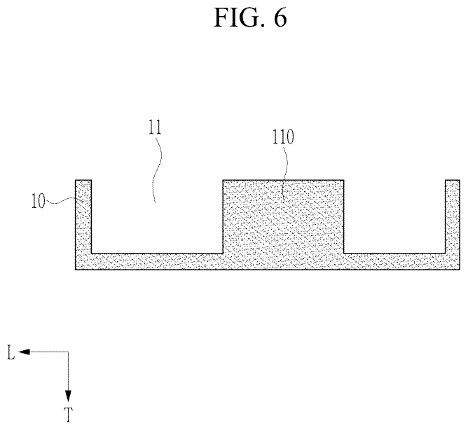

Referring to FIG. 6, a trench 11 is formed by etching the magnetic bar 10. For example, the trench 11 may be formed by irradiating a laser beam onto the magnetic bar 10 or performing a wet etch process on the magnetic bar 10.

The first trench 11 may be formed around the core 110.

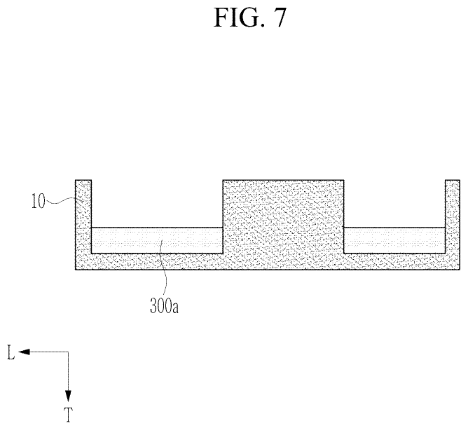

Referring to FIG. 7, a first insulation member 300a is formed by filling the first trench 11 with glass.

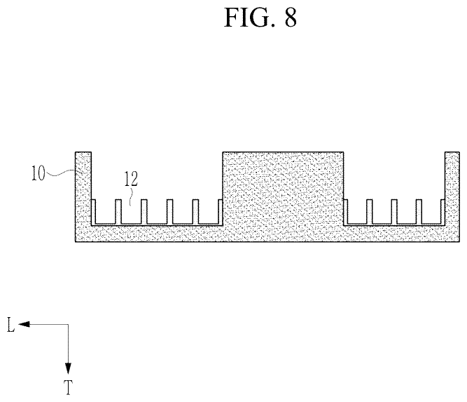

Referring to FIG. 8, a second trench 12 is formed by etching the first insulation member 300a. For example, the second trench 12 may be formed by irradiating a laser beam onto the first insulation member 300a or performing a wet etch process on the first insulation member 300a.

The second trench 12 may be formed to have various patterns. For example, the second trench 12 may be formed as a spiral.

Since the first insulation member 300a is made of glass, the second trench 12 may be formed to have a relatively high aspect ratio. That is, when a laser beam is irradiated onto the first insulation member 300a made of glass, the straightness of the laser beam is excellent, thereby increasing the aspect ratio of the second trench 12. For example, the aspect ratio of the second trench 12 may be 3:1 or more or 20:1 or less. As a result, since the second trenches 12 may be disposed within the first insulation member 300a at a relatively high density, and disposed to be closer to each other with a fine pitch.

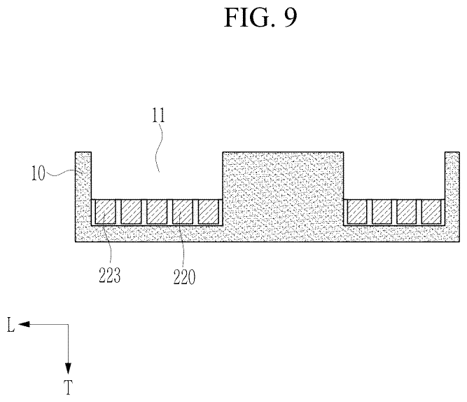

Referring to FIG. 9, a second coil pattern 220 is formed by filling the second trench 12 with metal. The metal filled in the second trench 12 forms the second coil pattern 220. For example, the second coil pattern 220 may be formed by plating the second trench 12 with copper (Cu). As a result, the second coil pattern 200, the second lead-out portion 223, etc., may be formed.

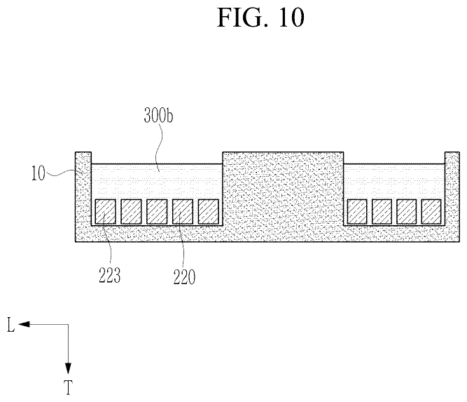

Referring to FIG. 10, a second insulation member 300b is formed by filling the remaining portion of the first trench 11 with glass to cover the second coil pattern 220.

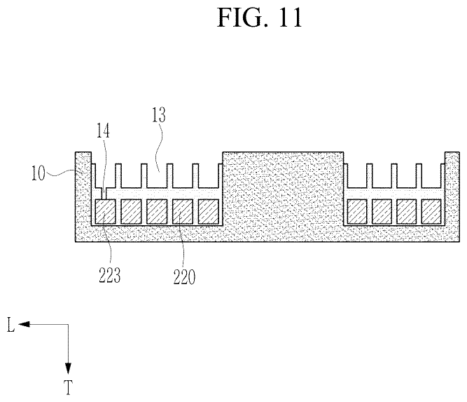

Referring to FIG. 11, a third trench 13 and a fourth trench 14 are formed by etching the second insulation member 300b. For example, the third trench 13 and the fourth trench 14 may be formed by irradiating a laser beam onto the second insulation member 300b or performing a wet etch process on the second insulation member 300b.

The third trench 13 may be formed to have various patterns. For example, the third trench 13 may be formed as a spiral.

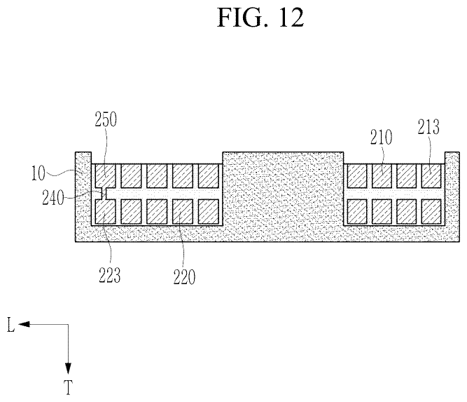

Referring to FIG. 12, the first coil pattern 210 is formed by filling the third trench 13 with metal, and a second via 240 is formed by filling the fourth trench 14 with metal. The metal filled in the third trench 13 forms the first coil pattern 210. For example, the first coil pattern 210 may be formed by plating the third trench 13 with copper (Cu). As a result, the first coil pattern 210, the first lead-out portion 213, the second via 240, the connection portion 250, etc., may be formed.

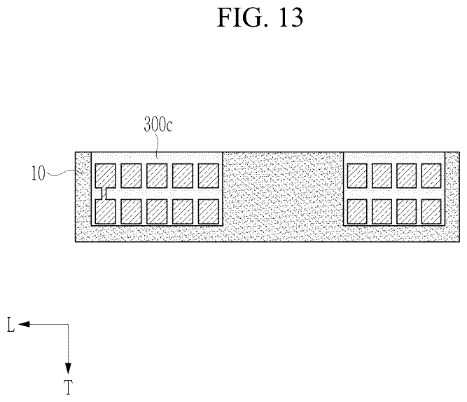

Referring to FIG. 13, a third insulation member 300c is formed by filling the remaining portion of the first trench 11 with glass to cover the first coil pattern 210.

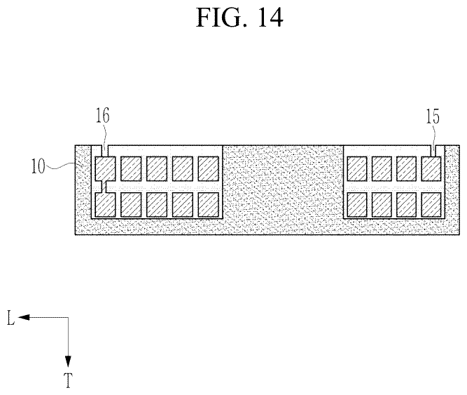

Referring to FIG. 14, a fifth trench 15 and a sixth trench 16 are formed by etching the third insulation member 300c.

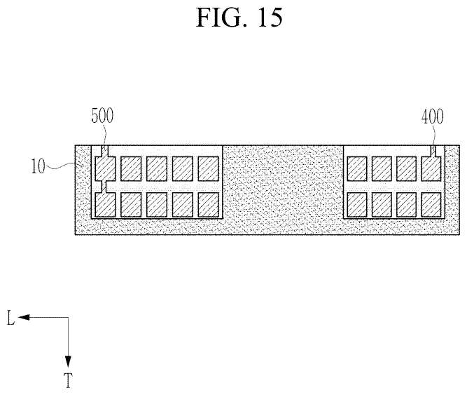

Referring to FIG. 15, the first lead-out terminal 400 and the second lead-out terminal 500 are formed by filling the fifth trench 15 and the sixth trench 16 with metal. For example, the first lead-out terminal 400 and the second lead-out terminal 500 may be formed by plating the fifth trench 15 and the sixth trench 16 with copper (Cu).

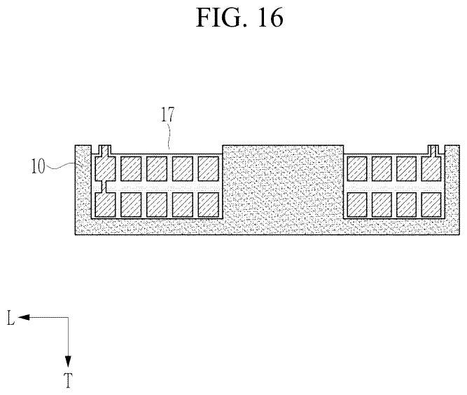

Referring to FIG. 16, a seventh trench 17 is formed by etching the third insulation member 300c.

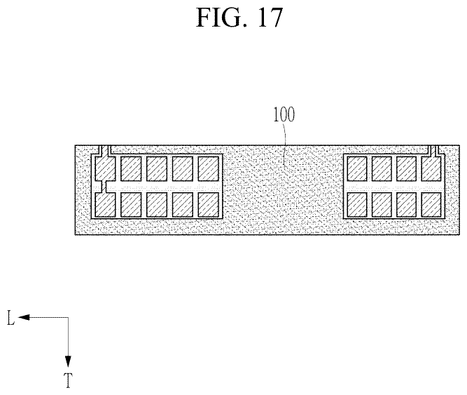

Referring to FIG. 17, a body 100 is formed by filling the seventh trench 17 with a magnetic material.

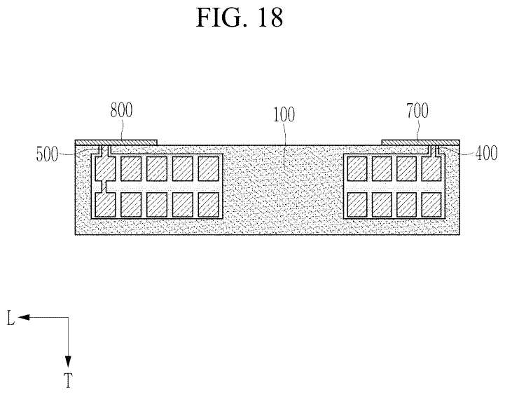

Referring to FIG. 18, a first external electrode 700 and a second external electrode 800 are formed on an outer surface of the body 100. For example, the first external electrode 700 may be formed by plating a metal to be in contact with the first lead-out terminal 400, and the second external electrode 800 may be formed by plating a metal to be in contact with the second lead-out terminal 500. As a result, the first external electrode 700 is connected to the first lead-out terminal 400, and the second external electrode 800 is connected to the second lead-out terminal 500.

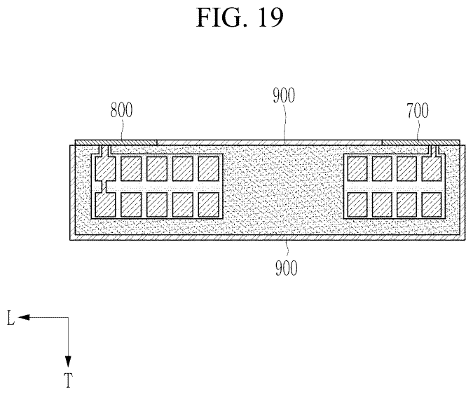

Referring to FIG. 19, a coil type electronic component 1000 is manufactured by forming a surface insulation layer 900 on an outer surface of the body 100, except for portions where the first external electrode 700 and the second external electrode 800 are formed.

Although the embodiment of the present disclosure has been described above, the present disclosure is not limited thereto. Various modifications can be made within the scope of the claims, the description of the present disclosure, and the accompanying drawings, all of which fall within the scope of the present disclosure.

### DESCRIPTION OF SYMBOLS

1000: Coil electronic component
100: Body
200: Coil
200a: First plating layer
200b: Second plating layer
210: First coil pattern
220: Second coil pattern
213: First lead-out portion
223: Second lead-out portion
300: Insulating member
300i: Internal insulating member
300e: External insulating member
300x: Insulation wall
400: First lead-out terminal
500: Second lead-out terminal
700: First external electrode
800: Second external electrode
900: Surface insulation layer

What is claimed is:

1. A coil type electronic component comprising:
a body including a magnetic material;
a coil embedded in the body and including a plating layer; and
an insulation member comprising glass and covering the coil,
wherein the plating layer comprises a first plating layer and a second plating layer covering the first plating layer.

2. The coil type electronic component of claim 1, wherein:
a portion of the first plating layer is in contact with the second plating layer and a remaining portion is in contact with the insulation member.

3. The coil type electronic component of claim 1, wherein:
the coil comprises a first coil pattern and a second coil pattern, and
the insulation member comprises an inner insulation member positioned between the first coil pattern and the second coil pattern.

4. The coil type electronic component of claim 3, wherein:
the inner insulation member comprises a first support surface and a second support surface facing each other, and
the first coil pattern is positioned on the first support surface, and
the second coil pattern is positioned on the second support surface.

5. The coil type electronic component of claim 4, further comprising:
a first via penetrating the inner insulation member, and connecting the first coil pattern and the second coil pattern.

6. The coil type electronic component of claim 1, wherein:
the insulation member comprises an outer insulation member positioned between the coil and the body.

7. The coil type electronic component of claim 6, wherein:
the outer insulation member is positioned on an outer surface of the coil.

8. The coil type electronic component of claim 6, wherein:
the second plating layer is in contact with the outer insulation member.

9. The coil type electronic component of claim 1, wherein:
the body includes a first surface and a second surface facing each other along a first direction,
the coil includes a plurality of turns wound about a winding axis in the first direction, and
the insulation member includes an insulation wall positioned between the turns of the coil.

10. The coil type electronic component of claim 1, wherein:
the insulation member comprises a photosensitive glass material.

11. The coil type electronic component of claim 1, wherein:
the insulation member comprises at least one selected from a group consisting of SiO₂—B₂O₃-based glass, SiO₂—B₂O₃—K₂O-based glass, SiO2—B₂O3—Li₂O—CaO-based glass, SiO₂—B₂O₃—Li₂O—CaO—ZnO-based glass, and Bi₂O3—B₂O3—SiO2—Al₂O3-based glass.

12. The coil type electronic component of claim 11, wherein:
the insulation member comprises at least one selected from a group consisting of quartz, alumina, magnesia, silica, forsterite (Mg₂SiO₄), steatite (H₂Mg₃(SiO₃)₄), and zirconia.

13. The coil type electronic component of claim 1, wherein:
the body comprises a first surface and a second surface facing each other along a first direction,
the coil is wound about a winding axis in the first direction, and
the coil comprises a lead-out terminal exposed at the first surface or the second surface of the body.

14. The coil type electronic component of claim 13, further comprising:
an external electrode disposed outside the body and connected to the lead-out terminal.

15. The coil type electronic component of claim 14, wherein:
the external electrode is disposed on the first surface or the second surface of the body.

16. The coil type electronic component of claim 1, further comprising:
a surface insulation layer disposed on an outer surface of the body.

17. A coil type electronic component comprising:
a body including a magnetic material;
a coil embedded in the body and including a plating layer;
an insulation member made of glass covering the coil; and
a first external electrode and a second external electrode disposed outside the body and connected to the coil,
wherein the insulation member comprises an insulation wall extending in a thickness direction between adjacent turns of the coil.

18. The coil type electronic component of claim 17, wherein:
the insulation wall is in direct contact with both a first coil pattern and a second coil pattern.
